(19) United States
(12) Patent Application Publication
(10) Pub. No.: US 2011/0250568 A1
(43) Pub. Date: Oct. 13, 2011

(54) DENTIN ANCHOR

(75) Inventor: Camilo Machado, Columbus, OH (US)

(73) Assignee: THE OHIO STATE UNIVERSITY RESEARCH FOUNDATION, Columbus, OH (US)

(21) Appl. No.: 12/756,757

(22) Filed: Apr. 8, 2010

(51) Int. Cl. A61C 5/04

(52) U.S. Cl. 433/225

(57) ABSTRACT

A fiber-reinforced composite (FRC) dentin anchor is disclosed comprising a frusto-conical shaped coronal portion, to which a tooth restorative material may be secured, and a frusto-conical shaped dentinal portion, adapted to be received in a pre-drilled hole in tooth dentin. The dentinal portion may be adapted to chemically bond to the tooth without the use of threads and the coronal portion may be adapted to chemically bond to a tooth restoration without the use of additional adhesives. The modulus of elasticity of the dentin anchor may approximate the modulus of elasticity of tooth dentin.

### BACKGROUND

Dentists commonly use stainless steel and titanium pins to reinforce large restorations in damaged but vital teeth (i.e., teeth that have suffered a substantial loss of tooth structure but do not have a root filling). Commonly used pins screw into pre-drilled holes in the dentin of the tooth. A portion of the pin projects out of the dentin so that the filling or restoration can be formed round it. Usually, the threaded portion of such pins are attached to a cylindrical shank designed to fit into the handpiece of a dental drill. The threaded portion of the pin is engaged in the hole in the tooth and is screwed in by the handpiece until it reaches the required depth, after which the pin breaks off, leaving the shank in the handpiece. Normally the resistance to further screwing-in of the threaded portion is sufficient to cause it to shear off at the neck. These types of pins suffer from several disadvantages, including the difficulty of aligning the pin with the pre-drilled hole in order to screw the pin into the dentine, the high sheer forces created in the dentin when the pin is screwed in, which can lead to tooth fracture.

Thus, there is a need for new anchorage systems that are easier to insert, cement, bond or attach and to reduce the amount of sheer stress created when placed into dentin, and preferably can form a chemical bond to the dentin and/or the restorative materials.

### SUMMARY

The present application generally discloses a fiber-reinforced composite (FRC) dentin anchor. More specifically, the present application discloses a dentin anchor made of fiber reinforced composite (FRC) material comprising a frusto-conical shaped coronal portion, to which a tooth restorative material may be secured, and a frusto-conical shaped dentinal portion, wherein the dentinal portion is shaped to be received in a pre-drilled hole in tooth dentin.

In some embodiments of the disclosed anchor, the dentinal portion is adapted to chemically bonded to the tooth by, for example, luting cement or other adhesive, without the use of threads. The dentinal portion may be frusto-conical shaped an have a shape similar to the frusto-conical shape of the coronal portion. The dentinal portion may be shaped to be received entirely or partially within the pre-drilled hole in the tooth dentin.

In some embodiments of the disclosed anchor, the modulus of elasticity of the dentin anchor approximates the modulus of elasticity of tooth dentin. Various fiber-reinforced composite material may be selected to achieve a modulus of elasticity of the dentin anchor similar to the modulus of elasticity of tooth dentin.

In some embodiments of the disclosed anchor, the coronal portion is adapted to chemically bond with the tooth restoration. In some embodiments, the fiber reinforced composite material of the dental anchor chemically bonds with a composite restoration without the use of cement or other adhesives. In other embodiments, the coronal portion may include a roughed surface, serrations, or other surface irregularities to enhance attachment to a tooth restoration.

Also provided is a method of restoring a tooth using one or more dentin anchors, comprising the steps of: preparing a hole in the tooth dentin shaped to receive a frusto-conical shaped dentinal portion of the dentin anchor, introducing a curable cement into the hole and/or onto said dentinal portion of the dentin anchor, placing said dentinal portion of the dentin anchor into the hole, curing the cement to secure the dentin anchor to the dentin, and placing a tooth restoration around the coronal portion of the dentin anchor.

Also provided is a dental bur for drilling a hole into tooth dentin comprising a cutting portion shaped to cut a hole which is complementary in shape to a portion of a dentin anchor.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 is a side view of an exemplary embodiment of a dentin anchor according to the present invention;

FIG. 2 is a side view of a second exemplary embodiment of a dentin anchor according to the present invention;

FIG. 3 is a side view of a third exemplary embodiment of a dentin anchor according to the present invention;

FIG. 4 is a side view of a fourth exemplary embodiment of a dentin anchor according to the present invention;

FIG. 5 is a side view of a fifth exemplary embodiment of a dentin anchor according to the present invention;

FIG. 6 is a side view of an exemplary embodiment of a dental bur for use with a dentin anchor;

FIG. 7 is a side view of a second exemplary embodiment of a dental bur for use with a dentin anchor;

FIG. 8 is a side view of a third exemplary embodiment of a dental bur for use with a dentin anchor;

FIG. 9 is a cross section of a tooth restored with a the dentin anchor of FIG. 1;

FIG. 10 is a partial cross section of a tooth restored with a fifth exemplary embodiment of a dentin anchor according to the present invention;

FIG. 11 is bar chart showing the results of compressive strength testing of amalgam (A) or composite (C) restorations reinforced with either a FRC dentin anchor (DA) according to the present invention or a metal pin (MP).

FIG. 12 is a bar chart showing the results of fatigue testing of amalgam (A) or composite (C) restorations reinforced with either a FRC dentin anchor (DA) according to the present invention or a metal pin (MP).

FIG. 13 is a schematic cross-section of an exemplary embodiment of a dentin anchor, illustrating the orientation of the fibers of the fiber reinforced material;

FIG. 14 is a schematic cross-section of second exemplary embodiment of a dentin anchor, illustrating the orientation of the fibers of the fiber reinforced material;

FIG. 15 is a schematic cross-section of a third exemplary embodiment of a dentin anchor, illustrating the orientation of the fibers of the fiber reinforced material;

FIG. 16 is schematic cross-section of a fourth exemplary embodiment of a dentin anchor, illustrating the orientation of the fibers of the fiber reinforced material;

FIG. 17 is a schematic cross-section of a sixth exemplary embodiment of a dentin anchor, illustrating the orientation of the fibers of the fiber reinforced material;

FIG. 18 is a schematic cross-section of a seventh exemplary embodiment of a dentin anchor; and

FIG. 19 is a schematic cross-section of an eighth exemplary embodiment of a dentin anchor.

### DETAILED DESCRIPTION OF ILLUSTRATED EMBODIMENT

The present invention will now be described with occasional reference to the specific embodiments of the invention. While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are incorporated by reference in their entirety.

Such a dentin anchor may be used for restoring a tooth which would normally be restored using a conventional metal pin. Such a tooth may be damaged through loss of substantial tooth structure. The tooth may be still vital, or the tooth may be non-vital and have a root canal filling but still have enough dentin around the root canal to support a restoration. Provided herein are also dental burs for drilling a hole into tooth dentin to receive the dentin anchor, methods of manufacturing the dentin anchor, and methods of restoring a tooth using the dentin anchors. The present invention will now be described with reference to more detailed examples. The examples illustrate how a person skilled in the art can make and use the invention, and are described here to provide enablement and best mode of the invention without imposing any limitations that are not recited in the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

### Dentin Anchor

Referring to FIG. 1, a first embodiment of a dentin anchor 10 is presented having a coronal portion 12, a central portion 14, and a dentinal portion 16. The coronal portion 12, the central portion 14, and the dentinal portion 16 may be configured in a variety of ways. Any fiber-reinforced composite structure having a dentinal portion capable of being received and secured in a pre-drilled hole in tooth dentin and a coronal portion capable of being attached to and supporting a tooth restoration may be used. For example, the portions may have any suitable cross-sectional shape such as circular, square, elliptical, rectangular, polygonal, etc. and any suitable length, width, diameter, etc. In the depicted embodiment, the dental anchor 10 has a generally cylindrical, elongated body (i.e. a circular cross-section) where the coronal portion 12 has a diameter A, the intermediate portion 14 has a substantially spherical shape with a diameter B that is greater than the diameter A, and the dentinal portion 16 has a diameter C that is smaller than the diameter B. Both the coronal portion 12 and the dentinal portion 16 are generally parallel sided.

In the depicted embodiment, the diameter A of the coronal portion 12 is equal to the diameter C of the dentinal portion 16. The coronal portion 20, however, may have a different cross section and diameter as compared to the dentinal portion 16. The dentin anchor 10 has a length D and the intermediate portion 14 has a length E.

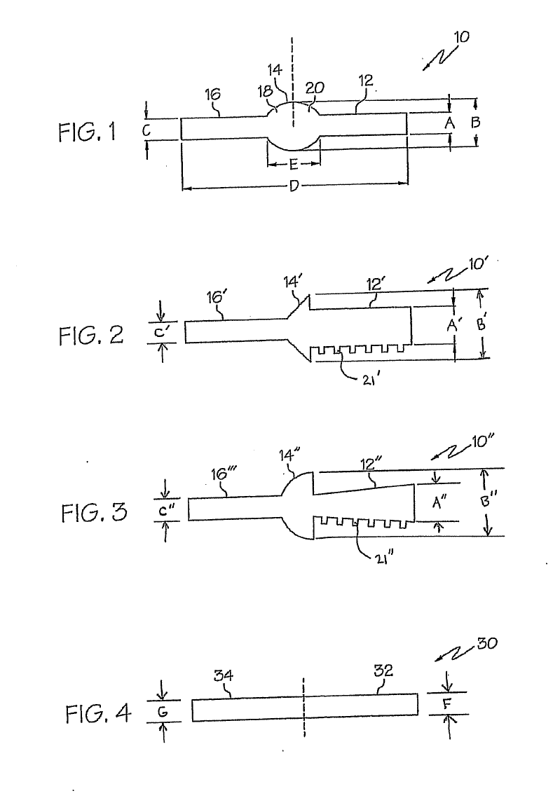

Referring to FIG. 2, a second embodiment of a dentin anchor 10′ is presented. The dentin anchor 10′ is similar to the dentin anchor 10 in that the dentin anchor 10′ has a coronal portion 12′, a central portion 14′, and a dentinal portion 16′. In the depicted embodiment, the dental anchor 10′ has a generally cylindrical, elongated body (i.e. a circular cross-section) where the coronal portion 12′ has a diameter A′, the intermediate portion 14′ has a substantially cone-like shape with a diameter B′ at the widest point, and the dentinal portion 16′ has a diameter C′ that is smaller than the diameter B′ and smaller than the diameter A′. Both the coronal portion 12′ and the dentinal portion 16′ are generally parallel sided.

To increase the retention of a restoration to the dentin anchor 10′, the coronal portion 12′ has serrations 21′ or other surface irregularities. As shown in FIG. 3, the serrations 21′ may be disposed on one side or portion of the coronal portion 12′, or alternatively, may be disposed around the entire circumference or outer surface of the coronal portion 12′.

Referring to FIG. 3, a third embodiment of a dentin anchor 10″ is presented. The dentin anchor 10″ is similar to the dentin anchor 10′ in that the dentin anchor 10″ has a coronal portion 12″, a central portion 14″, and a dentinal portion 16″. In the depicted embodiment, the dental anchor 10″ has a generally cylindrical, elongated body (i.e. a circular cross-section) where the coronal portion 12″ has a diameter A″ at the widest point, the intermediate portion 14″ has a substantially hemi-spherical shape with a diameter B″ at the widest point, and the dentinal portion 16″ has a diameter C″. The diameter C″ is smaller than the diameter B″ and smaller than the diameter A″. The dentinal portion 16″ is generally parallel sided while the coronal portion 12″ has a generally divergent shape. In the depicted embodiment, the divergent shape is similar to an isosceles trapezoid, though other divergent shapes are possible.

As with the dentin anchor 10′ of FIG. 2, the dentin anchor 10″ may have serrations 21″ or other surface irregularities on the coronal portion 12″ to increase the retention of a restoration to the dentin anchor 10″.

Referring to FIG. 4, a fourth embodiment of a dentin anchor 30 is presented. The dentin anchor 30 is similar to the dentin anchor 10′ in that the dentin anchor 30 has a coronal portion 32 and a dentinal portion 34. In the depicted embodiment, the dental anchor 30 has a generally cylindrical, elongated body (i.e. a circular cross-section) where the coronal portion 32 has a diameter F, and the dentinal portion 34 has a diameter G. Both the coronal portion 32 and the dentinal portion 34 are generally parallel sided and the diameter F of the coronal portion 32 is equal to the diameter G of the dentinal portion 34. In the depicted embodiment, the surfaces of the coronal portion 32 or dentinal portion 34 may be smooth. In other embodiments, however, the surfaces may be roughened, serrated, or contain other surface irregularities to increase the retention of a restoration to the dentin anchor 30.

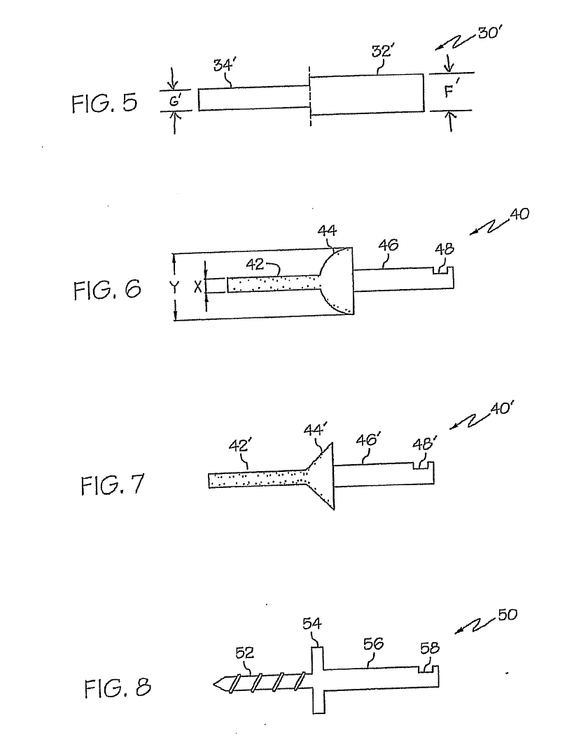

Referring to FIG. 5, a fifth embodiment of a dentin anchor 30′ is presented. The dentin anchor 30′ is similar to the dentin anchor 30 of FIG. 4 in that the dentin anchor 30′ has a coronal portion 32′ and a dentinal portion 34′. In the depicted embodiment, the dental anchor 30′ has a generally cylindrical, elongated body (i.e. a circular cross-section) where the coronal portion 32′ has a diameter F′, and the dentinal portion 34 has a diameter G′. Both the coronal portion 32′ and the dentinal portion 34′ are generally parallel sided and the diameter F′ of the coronal portion 32′ is greater to the diameter G′ of the dentinal portion 34′. In the depicted embodiment, the coronal portion 32′ and the dentinal portion 34′ are connected by a generally radially extending surface 33′ or shoulder.

In the depicted embodiment, the surfaces of the coronal portion 32′ are be smooth. In other embodiments, however, the surfaces may be roughened, serrated, or contain other surface irregularities to increase the retention of a restoration to the dentin anchor 30′.

Referring to FIG. 10, the dentin anchor 10 is illustrated installed in a tooth 80 that is restored with a dentin anchor retained restoration 82. To prepare a tooth for receiving the dentin anchor 10, a hole 84 is drilled in the cavity floor 85, using a bur (discussed below) driven by a dental handpiece. The hole 84 can be positioned between the enamel 86 and the pulp space 87 so that it sits entirely within tooth dentin 88. For example, the hole 84 can be positioned about 1 millimeter from the dentin-enamel junction 90, but the position of the hole 84 is usually dictated by the tooth type and the cavity shape. The depth and shape of the hole 84 corresponds to the particular dentin anchor to be used.

In the depicted embodiment in FIG. 10, the intermediate portion 14 of the dentin anchor 10 is shaped so that when the dentin anchor 10 is inserted into a pre-drilled hole 84 in tooth dentin 88, a dentinal portion 18 of the intermediate portion 14 is positioned inside the pre-drilled hole, while a coronal portion 20 of the intermediate portion 14 projects out of the dentin 88 coronally.

The dimensions of the dentin anchor 10 as a whole, and the dentinal portion 16 in particular, should be small enough so that the dentin anchor may be inserted within tooth dentin 88 without encroaching on the pulp space 87, the enamel 86, or the dentin-enamel junction 90. These dimensions, however, should be large enough to maintain the required rigidity, strength and physical properties of the dentin anchor 10. For the depicted embodiment, the diameter C of the dentinal portion 16 may range from about 0.3 millimeters to about 3 millimeters and the diameter A of the coronal portion 12 may range from about 0.5 millimeters to about 4 millimeters. The length D of the dentin anchor 10 may range from about 2.5 millimeters to about 6 millimeters. In one example of the dentin anchor 10 of FIG. 1, the diameter A is about 0.5 millimeters, the diameter B is about 1 millimeters, diameter C is about 0.5 millimeters, the length D is about 4 millimeters, and the length E is 1 about millimeters.

In another embodiment, such as dentin anchor 30 of FIG. 4, the diameter of the dentin anchor may be from about 0.3 millimeters to about 3 millimeters and its length may be from about 3 millimeters to about 6 millimeters. In one example of the dentin anchor 30, the diameter of the anchor is about 0.8 millimeters and a length of the anchor is about 4 millimeters.

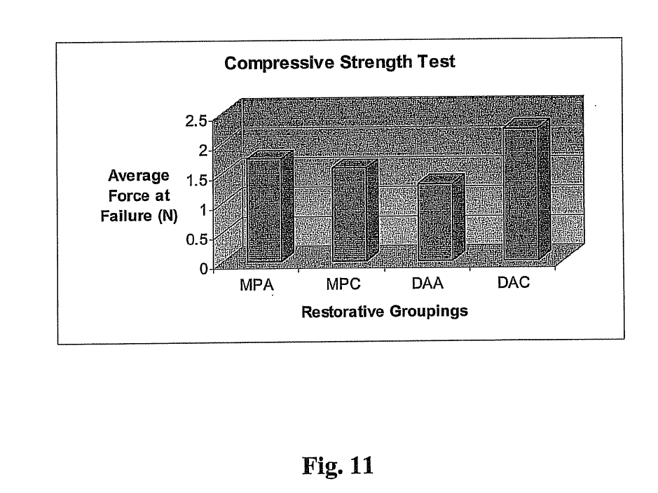

Referring to FIG. 11, a sixth embodiment of a dentin anchor 10′″ is presented. The dentin anchor 10′″ is similar to the dentin anchor 10″ of FIG. 3 in that the dentin anchor 10′″ has a coronal portion 12′″, a central portion 14′″, and a dentinal portion 16′″. In the depicted embodiment, the dental anchor 10′″ has a generally cylindrical, elongated body (i.e. a circular cross-section) where the coronal portion 12′″ has a diameter A′″, the intermediate portion 14′″ has a substantially hemispherical shape with a diameter B′″ at the widest point, and the dentinal portion 16′″ has a diameter C′″ at the widest point. The diameter C′″ is smaller than the diameter B′″ and smaller than the diameter A′″. The coronal portion 12′″ and the dentinal portion 14′″ is generally parallel sided.

In the depicted embodiment in FIG. 10, the intermediate portion 14′″ of the dentin anchor 10′″ is shaped so that when the dentin anchor 10′″ is inserted into a pre-drilled hole 84 the entire intermediate portion 14′″ is positioned inside the pre-drilled hole, while a coronal portion 12′″ projects out of the dentin 88 coronally.

Referring to FIG. 18, another embodiment of a dentin anchor 100 is presented. In this embodiment, the dentin anchor 100 includes two (2) frusto-conical shaped portions. One of the portions 102 is a frusto-conical shaped coronal portion, and the other portion 104 is a frusto-conical shaped dentinal portion. In the illustrated embodiment, a length (height) of the coronal portion 102 is about equal to a length (height) of the dentinal portion 104 (e.g., each of the coronal and dentinal portions 102, 104, respectively, is about 2.50 mm).

A diameter of the wider end 106 of the dentinal portion 104 of the dentin anchor 100 is substantially equal to a diameter of the narrower end 110 of the coronal portion 102. In the illustrated embodiment, the diameters of the wider end 106 of the dentinal portion 104 and the narrower end 110 of the coronal portion 102 are about 0.75 mm, although other diameters are also contemplated. Except for the point where the diameters of the dentinal and coronal portions 104, 102, respectively, are substantially equal, a diameter of the dentinal portion 104 is smaller than a diameter of the coronal portion 102. The diameter of the narrower end 112 of the dentinal portion 104 is about 0.5 mm, and a diameter of the wider end 114 of the coronal portion 102 is about 1.00 mm. Also, an angular distance across the dentin anchor 100 is about 5.725°.

It is contemplated that substantially all of the dentinal portion 104 (e.g., 2.50 mm) of the anchor 100 is received into a hole in a tooth dentin. Therefore, in the illustrated embodiment, about 2.50 mm of the dentin anchor 100 is received into the hole in the tooth dentin. Once the anchor 100 is received into the tooth dentin, the relatively larger diameter at the wider end 114 of the coronal portion 102, which extends from the tooth dentin, mechanically anchors the tooth restorative material to the coronal portion 102.

Referring to FIG. 19, another embodiment of a dentin anchor 120 is presented. It is to be understood that the dentin anchor 120 is shaped substantially the same as the dentin anchor 100 (see FIG. 18), although some of the dimensions of the dentin anchor 120 are different (e.g., larger) than the dimensions of the dentin anchor 100 (see FIG. 18). For example, point where the diameters of the narrow end of the coronal portion 122 and the larger end of the dentinal portion 124 are substantially equal is illustrated as having a diameter of about 1.50 mm. The diameter at the narrower end of the dentinal portion 124 is illustrated as about 1.00 mm, while the diameter at the wider end of the coronal portion 122 is illustrated as about 2.00 mm. Also, an angular distance across the dentin anchor 100 is about 11.421°.

Although the diameters of the dentin anchor 120 are larger relative to the dentin anchor 100 (see FIG. 18), the lengths (heights) of the coronal portion 122 and the dentinal portion 124 are about 2.50 mm each. Therefore, the total length of the dentin anchor 120 is about 5.00 mm, which is substantially the same length (height) as the dentin anchor 100 (see FIG. 18).

### Complementary Bur

To restore a tooth with the dentin anchor as disclosed in the present application, a hole is typically cut into the dentin of the tooth to receive the dentin anchor. Accordingly, it is desirable to have a bur that is complementary in shape to the portion of the dentin anchor that is to sit within the hole.

FIG. 6 illustrates a dental bur 40 for cutting a hole to receive the dentin anchor 10 of FIG. 1. The dental bur may be configured in a variety of ways. Any structure capable of forming a hole in dentin that is complementary of the dentinal portions of the dentin anchor may be used. In the depicted embodiment, the dental bur 40 has two cutting portions 42 and 44, which together have a shape complementary to the dentinal portion 16 and the dentinal portion 18 of the intermediate portion 14, respectively, of dentin anchor 10. The bur 40 also includes a non-cutting cylindrical shank 46 and a latching portion 48. The latching portion 48 may be configured in a variety of ways. Any structure capable of attaching to a drill or handpiece that is suitable for us in dentistry may be used. For example, the latching portion may be a standard configuration for attaching to a known latching mechanism in a dental slow-handpiece or drill, though nonconventional or newly developed configurations are also possible. In the depicted embodiment, the latching portion 48 is realized as a notch or other non-circular cross-section that may be gripped by a latching mechanism of a dental slow-handpiece or drill.

The cutting portion 42 has a diameter X which is slightly larger than the diameter C of the dentinal portion 16 of the dentin anchor 10. The cutting portion 44 is shaped to be complementary to, but dimensioned slightly larger than, the dentinal portion 18 of the intermediate portion 14. These discrepancies in dimension need only be large enough to accommodate a thin layer of a luting cement between the dentinal portions 16, 18 of the anchor 10 and the interior walls of the hole cut into the dentin 88 so that the dentin anchor 10 may be adequately cemented into place. Dental bur 40 may also be used with dentin anchors 10″ of FIG. 3 and dentin anchor 10′″ of FIG. 11.

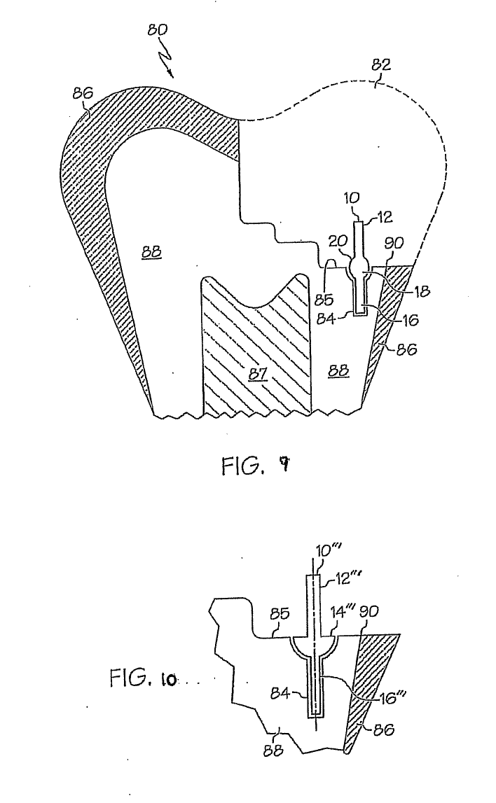

FIG. 7 shows an embodiment of a bur 40′ which is complementary to, and is to be used with, the dentin anchor 10′ of FIG. 2. As explained above regarding the bur 40, the cutting portions 42′ and 44′ of the bur 40′ are shaped to be complementary, but slightly larger than, the dentinal portions 16′ and 18′ of the dentin anchor 10′.

FIG. 8 shows an embodiment of a dental bur 50 for use with the dentin anchor 30. The bur 50 has a cutting portion 52 and a stop shoulder 54, as well as a shank 56 and a latching mechanism 58. The cutting portion 52 is essentially cylindrical in shape and dimensioned to be slightly larger than the dentinal portion 34 of dentin anchor 30. The stop shoulder 54 is non-cutting and acts to stop the bur from penetrating the dentin any further once the desired depth has been reached. In one embodiment, the cutting portion 52 is about 2 millimeters in length and the stop shoulder 54 ensures that each hole that is cut is no deeper than 2 millimeters.

While, in the foregoing, embodiments of the present invention have been set forth in considerable detail for the purpose of making a complete disclosure of the invention, it will be apparent to those skilled in the field that other embodiments exist for the dentin anchor and its complementary bur that do not depart from the spirit of the invention. Thus, the described embodiments are illustrative and should not be construed as restrictive. For example, all the dental burs described may have, instead of a latching portion 48 or 58, a non-cutting shank that is capable of fitting into a standard friction-grip fast dental handpiece. Also, the cutting portions 42, 42′ or 52 of the burs may be constructed in any way customary in the art (e.g. diamond, stainless steel, tungsten carbide, etc.) for operation with either a slow or fast dental handpiece.

### Manufacturing the FRC Dentin Anchor

The embodiments of the dentin anchors disclosed in the present application may be made of fiber reinforced composite (FRC) resin that is biocompatible and closely resembles the natural appearance of a tooth. As a result, natural appearance of the final restoration may be enhanced. In addition, the FRC materials used in the dentin anchors (discussed below) have a high flexural strength (up to 1280 MPa) and an elastic modulus of

The FRC dentin anchors disclosed in the present application may be manufactured by molding. An example of a method of manufacturing the dentin anchor of claim includes providing a mold corresponding to the shape of the dentin anchor to be manufactured, filling the mold cavity with the appropriate fiber reinforced composite (FRC) material or polymer; and curing (polymerization) the FRC material according to the manufacturer's instructions to obtain the desired dentin anchor. After curing, the dentin anchor is removed from the mold. Further curing may be carried out under light and heat.

The mold may be constructed in any suitable manner. In one example, the mold is constructed to be light transmissible to take advantage of materials used in fabricating the dentin anchor that are polymerized using light. The mold may be filled with a resinous matrix prior to the fibers being added. The resinous matrix may be composed of a monomer, a polymer or a polymer monomer mixture and optionally filler materials such as ceramic powder and/or opaquers, plasticizers, etc.

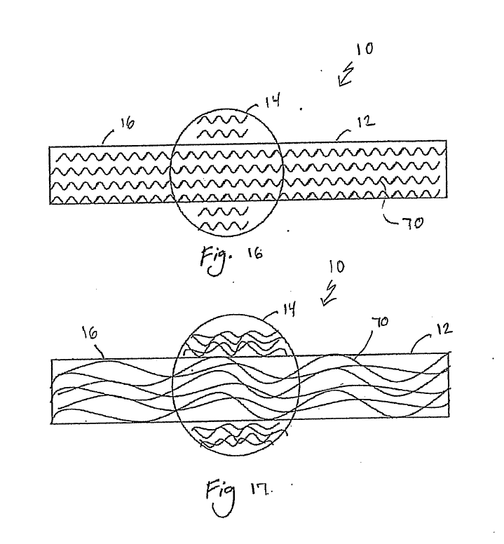

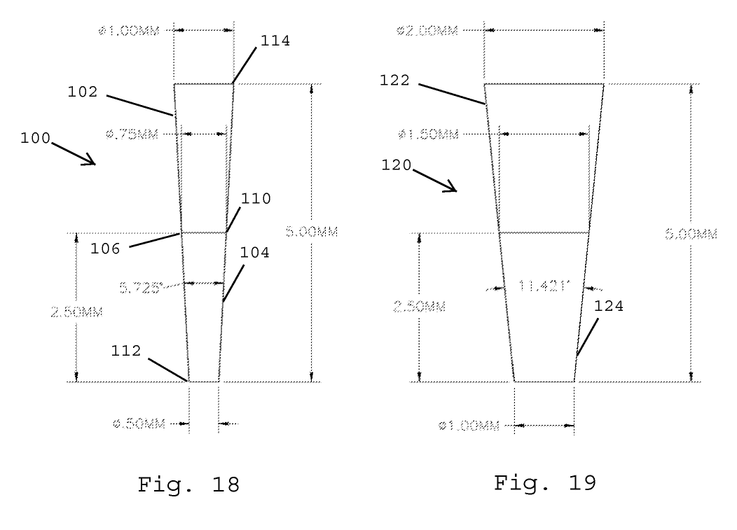

Referring to FIGS. 13-17, the embodiment of dentin anchor 10 is schematically represented. The fibers 70 in the dentin anchor may be oriented in a variety of ways. Any orientation of the fibers that enhances the strength the anchor may be used. For example, the fibers 70 in the coronal portion 12, the intermediate portion 14, and the dentinal portion 16 of the dentin anchor 10 may be established in the same or approximately the same orientation. For example, as depicted in FIG. 13, the fibers 70 are generally aligned parallel to a longitudinal axis of the anchor and in FIG. 16 the fibers are non-axially aligned in approximately the same orientation. Alternatively, the fibers 70 in the intermediate portion 14 may be established in a different orientation to the fibers in the coronal portion 14 or dentinal portion 16. For example, as depicted in FIG. 14, the fibers in the intermediate portion are non-axially aligned with respect to a longitudinal axis of the anchor. Furthermore, the fibers 70 in the intermediate portion 14 of the anchor may be established in a combination of orientations (align axially and non-axially), as shown in FIG. 15, or may be randomly orientated, as shown in FIG. 17.

The FBC material may be manufactured from a variety of suitable materials. The fibers of the FRC materials of choice may be essentially continuous and may be unidirectional, braided, woven or in non-woven form. The fibers may be fabricated from glass, silica, carbon, graphite, quartz, Kevlar, polyethylene or other thermoset or thermoplastic materials or a combination of these materials, although they can be formed from any other material which is physiologically inert and capable of enhancing the strength of the composite resin or plastic in which they are contained.

The FRC fibers may be embedded in a variety of a thermoplastic or thermoset synthetic resins. For example, the resin may be any physiologically inert and curable resin, such as but not limited to the following: polyethylene, polypropylene, acrylic, polycarbonate, epoxy, polysulfone, bisphenol A-glycidylmethacrylate (Bis-GMA) resin, Nylon 6, isosite, or a combination thereof.

Some commercially available FRC fibers are impregnated with an organic matrix such as polymethyl methacrylate (PMMA) but require wetting with resin before they can be cured. An example of such a material includes first generation Stick® (Stick Tech Ltd, Turku, Finland) which contains silanized glass fibers impregnated with PMMA.

Other commercially available FRC fibers are pre-impregnated with resin so that they do not require wetting before polymerization. Examples of this type of reinforcing fibers include, but are not limited to, pre-impregnated unidirectional glass fibers available commercially as Fiberkor® (Jeneric/Pentron Inc, Wallingford, Conn.), Vectris® (Ivoclar Vivadent, Inc., Amherst, N.Y.), and EverStick® (Stick Tech Ltd, Turku, Finland). These fibers reinforce the resultant FRC materials and confer a high flexural strength (up to 1280 MPa) and a modulus of elasticity of up to 28 GPa. The elastic modulus of dentin is about 18 GPA, therefore the elastic modulus of these materials is close to that of dentin.

Vectris®, for example, is a light-curing, translucent, tooth-colored FRC material that is suitable for manufacturing the disclosed dentin anchors. Vectris® features glass-fiber bundles embedded in an organic polymer matrix and exhibits high flexural strength and stability. It is also an aesthetic and translucent material. Vectris® has a composition comprising pre-impregnated E-glass fibers (65%), BIS-GMA (24.5%), decandiol dimethacrylate (0.3%), triethyleneglycol dimethacrylate (6.2%), urethane dimethacrylate (0.1%), highly dispersed silica (3.5%) catalysts and stabilizers (<0.3%) and pigments (<0.1%).

Other suitable materials include EverStick® and second generation Stick® fibers, which are pre-impregnated with both PMMA and light-curing resin. The fibers are also coated with a thin layer of resin that contains PMMA. The Bis-GMA allows EverStick® fibers to bond with light cure composites as well as acrylic (PMMA). The EverStick® fiber provides approximately 28 MPa of strength to etched enamel/dentin and approximately 27 MPa to fiber reinforced composite (see T. M. Lastumäki et al. Journal of Materials Science Materials in Medicine 14 (2003) pp. 1-7). The increase in bond strength is achieved by utilizing a unique interpenetrating polymer network (IPN) structure within Stick® and EverStick® polymer matrices. Thus, the polymer matrix is able to partially dissolve in the resin used for bonding. The PMMA pre-impregnation, used in both Stick® and EverStick®, is performed by using a thermoplastic polymer which is capable of dissolving into the resins used for wetting, luting (cementing) and composite restorations. The surface of the fiber framework is partially dissolved with resin, resulting in a micro mechanical as well as a chemically bonded interface. Consequently, a fiber-polymer structure is obtained that has a flexural strength of about 900-1280 MPa.

FiberKor®, which is made of pre-impregnated S-glass fibers (˜60%) in a 100% Bis-GMA matrix, is also a suitable material for use in manufacturing the dentin anchors disclosed herein.

As an example, to construct a cylindrical dentin anchor such as the dentin anchor 30 depicted in FIG. 4, clear plastic tubing with an internal diameter of about 0.8 millimeters is used as the mold. The mold is filled with the FiberKor® liquid using an applicator. For better handling, bundles of Fiberkor® fibers may be made by putting together approximately 20 pre-impregnated fibers in each bundle and light curing them for a few seconds. Approximately 5 such bundles are inserted into the mold and the mold was light cured in a curing unit for approximately three minutes. After curing (polymerization), the plastic tube is sectioned and removed and the cylindrical FRC material may be cut into 4 millimeters long anchors.

### Method of Restoration Using a Dentin Anchor

To restore a tooth with the dentin anchor of the present invention, the following procedure may be followed. It is understood, however, that this is an example of the restorative procedure and those skilled in the art may alter the method, or use alternative materials to the ones recited in this example, without departing from the spirit of the invention. Thus, this example is recited to provide enablement and best mode of the invention without imposing limitations that are not recited in the claims.

Referring to FIG. 10, to prepare the tooth 80 for receiving the dentin anchor 10, the hole 84 is drilled in the cavity floor 85, using a bur (such as a bur 40 of FIG. 6) driven by a dental handpiece. As previously discussed, the hole 84 can be positioned between the enamel 86 and the pulp space 87 so that it sits entirely within tooth dentin 88 about 1 millimeter from the dentin-enamel junction 90. Next, the hole may be acid etched with a suitable acid etching material, such as Gel Etchant (from Kerr Dental), which is a 37.5% phosphoric acid gel. After rinsing the acid etchant off, the dentin anchor is cemented into place using a suitable luting cement. A dentin bonding agent may be used together with the luting cement. Suitable cements include self-curing, single light cure or dual cure adhesive luting agents and are applied according to their manufacturer's instructions (see M J Tyas, M F Burrow, Adhesive restorative materials: A review, Australian Dental Journal 2004; 49:(3):112-121).

An example of a suitable bonding agent is Optibond® Solo Plus™ or Optibond® Solo Plus™ Dual Cure (from Kerr Dental). When using this bonding agent, the liquid adhesive is first painted over the dentin in the hole and is light cured according to the manufacturer's instructions (about 10 seconds). The Optibond® cement is then applied to the dentin anchor (or the hole), the dentin anchor is placed in the hole, and the cement is light cured according to the manufacturer's instructions (about 40 seconds).

Once the dentin anchor has been cemented into place, the tooth is restored with a suitable restorative material including, amalgam, glass ionomer, composite resin, or any other suitable material. The restorative materials may be reinforced with other suitable materials to enhance strength of the restoration. The restorations may be chemically bonded to the dentin anchor. In the case of composite resin restorations, the composite restorations themselves will form a chemical bond with the dentin anchor because the dentin anchor is made of FRC material.

Since, the FRC dentin anchors are not screwed into dentin for mechanical retention but are chemically bonded to dentin, the dentin anchors do not produce the sheer forces which are produced when metal pins are inserted into dentin. Additionally, the chemical bonding of FRC materials to dentin, and to composite resin or other restorations, enhances the strength of the dentin anchors and improves the distribution of forces along the pin-dentin and pin-restoration interface.

The present invention will be better understood by reference to the following examples which are offered by way of illustration not limitation.

### Example 1

### Comparison of FRC Dentin-Anchors and Metal Pins

To test the effectiveness of FRC dentin anchors as compared with conventional metallic screw pins in large tooth restorations, the performance of restorations using FRC dentin anchors was evaluated in compressive force tests with and without fatiguing and was compared to the performance of restorations with conventional metallic screw pins.

Materials and Methods: Forty (40) freshly extracted maxillary premolars were mounted in acrylic resin. The teeth were divided into four groups of ten: the teeth in the first group received FRC dentin anchors with composite restorations (DAC); the teeth in the second group received FRC dentin anchors with amalgam restorations (DAA); the teeth in the third group received metal pins with composite restorations (MPC); and the teeth in the final group received metal pins with amalgam restorations (MPA).

To prepare the teeth, the lingual cusp of each tooth was removed. Metal pins or FRC anchors were placed in the dentin, about 1 millimeter from the enamel-dentin junction, and the cusps were restored to their original level with amalgam or composite. The method of placing an FRC dentin anchor and restoration within a tooth was consistent with the process described above in this specification. The metal pins were placed as follows: a 2 millimeter hole was drilled using a Thread-Mate System (TMS) bur in a slow speed dental handpiece. A TMS Minim pin was then threaded into place according to the manufacturer's instructions, and the tooth was restored with either composite (using Prodigy® from Kerr Dental) or amalgam.

Each group of ten teeth was divided into two subgroups: one subgroup (five teeth) from each group was tested for compressive strength in an Instron Universal Testing Machine and the other subgroup (five teeth) was fatigued in a chewing machine for one million cycles at 200 N, followed by one million cycles at 400 N, followed by one million cycles at 600 N. Those teeth that survived the fatiguing process were tested to failure for compressive strength in the Instron machine.

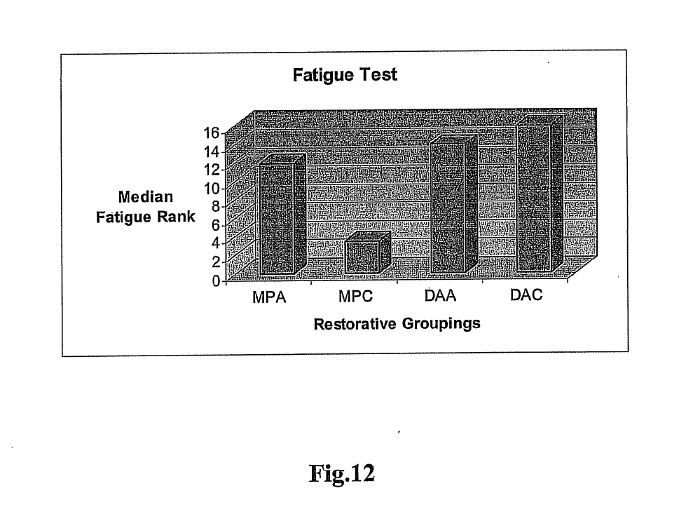

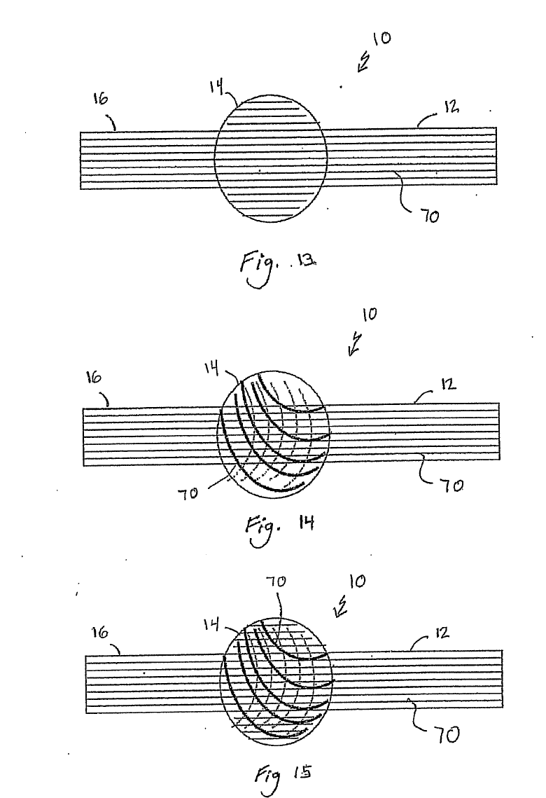

Results: FIG. 12 shows the results of the compressive strength tests by depicting the average force at failure (N) for each group. FIG. 13 shows the results of the fatigue tests by depicting the median fatigue rank for each group. Fatigue rankings were assigned as follows: the first tooth to fail received the lowest rank and the last tooth to fail was given the highest rank. Due to the non-normal character of the data, the data was ranked using a non-parametric one-way ANOVA test. The fatigue test results show that FRC dentin anchors had a mean score of 13.35 while metal pins had a mean score of 7.65 (chi-squared 4.7195, DF=1, p=0.030). Thus, restorations with FRC dentin anchors were found to be significantly more resistant to fatigue than restorations with metal pins. There was no significant difference between the compressive strength of the two groups restored with FRC dentin anchors.

### Example 2

### Effect of Fiber Pins on the Fracture Resistance of Reattached Incisor Fragments

Objectives: To assess the influence of fiber pins on the in-vitro fracture resistance of reattached coronal fragments of incisors.

Methods: Forty-five extracted sound central upper incisors were selected. The specimens were cut horizontally with a diamond blade of 0.25 millimeter, 4 millimeter below the incisal edge to simulate fracture. Three restoration designs were tested with 15 randomly selected specimens for each group (see Table I). In Groups A and B coronal fragments were reattached by bonding the fragment to the tooth (Panavia F, Kuraray). In Group B two fiber pins were placed in the tooth and holes were prepared in the coronal fragment, before reattachment of the coronal fragment. Group C consisted of specimens with a restoration of resin composite (AP-X, Kuraray). After restoration, all specimens were subjected to static load tests at an loading angle of 45°. For each test, the load until fracture and failure mode were registered.

Results: Differences in fracture loads between the groups were statistically significantly (Kruskal-Wallis, p<0.05). Post-hoc analysis revealed statistically significant differences between all three groups (Mann-Whitney, p<0.05). Fracture of tooth material cervical of the simulated fracture line was observed more frequently in Groups B and C than in Group A (Chi-square, p<0.05).

TABLE I

| | | | Fracture of tooth material below | |
|---|---|---|---|---|
| | | Mean fracture | simulated fracture line | |
| Group | n | load in N (SD) | Yes | No |
| A | 15 | 255 (108) | 0 | 15 |
| B | 15 | 599 (465) | 11 | 4 |
| C | 15 | 786 (197) | 8 | 7 |

Conclusion: The results suggest that application of FRC pins increase the static load-bearing capacity of reattached coronal fragments in incisors. However, failures of fractured incisors restored with FRC pins seem to affect the tooth more dramatically than those without.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A dentin anchor, comprising:
a frusto-conical shaped coronal portion, to which a tooth restorative material may be secured, and
a frusto-conical shaped dentinal portion received in a pre-drilled frusto-conical shaped hole in tooth dentin.

2. The dentin anchor as set forth in claim 1, wherein the fibers for the fiber reinforced composite material are selected from one or combinations of the group comprising: glass, silica, quartz, carbon, graphite, Kevlar, ceramic, polyethylene, and a combination thereof.

3. The dentin anchor as set forth in claim 1, wherein the fibers of the fiber reinforced composite material are embedded in a synthetic resin chosen from a group comprising: polyethylene, polypropylene, acrylic, polycarbonate, epoxy, polysulfone, Bis-GMA resin, Nylon 6, isosite, ceramic or other materials, and a combination thereof.

4. The dentin anchor as set forth in claim 1, wherein the modulus of elasticity of the dentin anchor approximates the modulus of elasticity of tooth dentin.

5. The dentin anchor as set forth in claim 1, wherein a diameter of the wider end of the dentinal portion of the dentin anchor is substantially equal to a diameter of the narrower end of the coronal portion.

6. The dentin anchor as set forth in claim 5 wherein the diameters of the wider end of the dentinal portion and of the narrower end of the coronal portion are about 0.75 mm.

7. The dentin anchor as set forth in claim 6, wherein:
a diameter of the narrower end of the dentinal portion is about 0.50 mm; and
a diameter of the wider end of the coronal portion is about 0.1.00 mm.

8. The dentin anchor as set forth in claim 5, wherein:
a diameter of the dentinal portion is smaller than a diameter of the coronal portion;
substantially all of the dentinal portion is received in the tooth dentin; and
the relatively larger diameter of the coronal portion extending from the tooth dentin mechanically anchors the tooth restorative material to the coronal portion.

9. The dentin anchor as set forth in claim 1, wherein about one-half of the dentin anchor is received in the tooth dentin.

10. The dentin anchor as set forth in claim 1, wherein the coronal portion comprises serrations for strengthening the attachment between the dentin anchor and a tooth restoration.

11. The dentin anchor as set forth in claim 1, wherein the dentinal portion of the dentin anchor is unthreaded.

12. The dentin anchor as set forth in claim 1, wherein the dentin anchor is fabricated from a light transmissible fiber reinforced composite material.

13. The dentin anchor as set forth in claim 1, wherein an angular distance across the dentin anchor is about 5.725°.

14. The dentin anchor as set forth in claim 1, wherein:
a height of the coronal portion is about 2.50 mm;
a height of the dentin portion is about 2.50 mm; and
substantially all of the dentin portion is received in the tooth dentin.

15. The dentin anchor as set forth in claim 1, wherein the coronal portion is constructed of a material that chemically bonds with a tooth restoration.

16. A dentin anchor for use in anchoring a dental restoration to the dentin or enamel of a damaged vital or non-vital tooth, the dentin anchor comprising:
a frusto-conical shaped elongated body formed from a fiber reinforced composite, the elongated body including:
a frusto-conical shaped dentinal portion received in a pre-drilled frusto-conical shaped hole in the dentin or enamel of the damaged tooth; and
a frusto-conical shaped coronal portion shaped to receive and anchor the restoration, a diameter of the coronal portion being larger than a diameter of the dentin portion.

17. The dentin anchor of claim 16, wherein the coronal portion chemically bonds to the dental restoration.

18. The dentin anchor of claim 16, wherein:
a height of the dentinal portion is about 2.50 mm;
a height of the coronal portion is about 2.50 mm; and
the dentinal portion extends about 2.50 mm into the dentin or enamel of the damaged vital or non-vital tooth.

19. The dentin anchor of claim 18, wherein:
a diameter of the wider end of the dentinal portion of the dentin anchor is substantially equal to a diameter of the narrower end of the coronal portion.

20. The dentin anchor as set forth in claim 16, wherein the fiber reinforced composite is formed from a physiologically-inert, curable synthetic resin and multiple physiologically-inert elongated fibers.

21. The dentin anchor as set forth in claim 16, wherein the modulus of elasticity of the dentin anchor approximates the modulus of elasticity of tooth dentin.

22. The dentin anchor as set forth in claim 16, wherein the dentinal portion of the anchor is unthreaded.

23. The dentin anchor as set forth in claim 16, wherein the fiber reinforced composite is formed from a resin selected from the group consisting of polyethylene, polypropylene, acrylic, polycarbonate, epoxy, polysulfone, bisphenol A-glycidylmethacrylate (Bis-GMA) resin, Nylon 6, isosite, and combinations thereof and fibers selected from the group consisting of glass, silica, carbon, graphite, quartz, Kevlar, polyethylene and combinations thereof.

24. A method of restoring a tooth using one or more dentin anchors, comprising:
preparing a frusto-conical shaped hole in the tooth dentin shaped to receive a portion of a dentin anchor;
introducing a curable cement into the hole and/or onto said dentinal portion of the dentin anchor;
placing a frusto-conical shaped dentinal portion of a fiber reinforced composite dentin anchor into the frusto-conical shaped hole;
curing the cement to secure the frusto-conical shaped dentin anchor to the dentin; and
placing a tooth restoration around a frusto-conical shaped coronal portion of the dentin anchor, the frusto-conical shape of the coronal portion anchoring the tooth restoration to the coronal portion.

25. The dentin anchor as set forth in claim 24, wherein the step of placing a tooth restoration around a coronal portion of the dentin anchor further comprises chemically bonding the tooth restoration to the coronal portion.
